(19) United States
(12) Patent Application Publication
(10) Pub. No.: US 2017/0177912 A1
(43) Pub. Date: Jun. 22, 2017

(54) SYSTEM FOR, AND METHOD OF, READING RADIO FREQUENCY IDENTIFICATION TAGS IN A CONTROLLED AREA IN REAL TIME WITH AN ENHANCED PERFORMANCE

(71) Applicant: SYMBOL TECHNOLOGIES, LLC, Lincolnshire, IL (US)

(72) Inventors: Michael J. Koch, Fort Salonga, NY (US); Benjamin J. Bekritsky, Modin (IL)

(21) Appl. No.: 14/975,931

(22) Filed: Dec. 21, 2015

(51) Int. Cl. G06K 7/10

(52) U.S. Cl. CPC G06K 7/10366

(57) ABSTRACT

A radio frequency identification (RFID) tag reading system and method read RFID tags in a controlled area in real time with an enhanced performance. An RFID reader reads a mixed tag population of interesting RFID tags and of uninteresting RFID tags in the controlled area at a read rate. A controller dynamically and continuously monitors the read rate in real time, dynamically selects the interesting RFID tags, or deselects the uninteresting RFID tags, in real time when the read rate is below a reading threshold, and dynamically controls the RFID reader in real time to only read the interesting RFID tags when the read rate is below the reading threshold.

### BACKGROUND OF THE INVENTION

The present disclosure relates generally to a system for, and a method of, reading radio frequency (RF) identification (RFID) tags in a controlled area in real time with an enhanced performance, especially for rapidly and accurately locating and tracking RFID tags associated with items of interest for inventory control.

It is known to deploy a radio frequency (RF) identification (RFID) system in a retail, factory, or warehouse environment, or a like controlled area or venue, for product locationing, product tracking, product identification, and inventory control. For example, in order to take an inventory of items associated with RFID tags in a warehouse environment or venue, it is known to position a plurality of RFID tag readers at overhead, fixed locations, or at doorways, loading docks, and assembly lines, in the venue, and then, to operate each such reader, under the control of a network host computer or server, to form and steer an interrogation beam, both in azimuth, e.g., over an angle of 360 degrees around a vertical axis, and in elevation, e.g., over an angle of about 90 degrees away from the vertical axis, over a coverage range across any such tags to read their payloads. Each RFID tag is usually attached to, or associated with, an individual item, or to a package for the item, or to a pallet or container for multiple items, or to a freight mover, such as a forklift truck, for moving such items, packages, or pallets in the venue. Each RFID tag typically includes an antenna, a power management section, a radio section, and frequently a logic section, a memory, or both. A multitude of such tags may be in the coverage range of each RFID reader.

In brief, each RFID reader transmits an RF interrogating signal, and each RFID tag, which senses the interrogating RF signal, responds by transmitting a return RF signal. Each RFID tag either generates the return RF signal originally, or reflects back a portion of the interrogating RF signal in a process known as backscatter. The return RF signal may further encode data stored internally in the tag. The return signal is demodulated and decoded into identification data (also known as the payload) by each reader, which thereby identifies, counts, or otherwise interacts with the associated item. The decoded data can denote a serial number, a price, a date, a destination, a location, other attribute(s), or any combination of attributes, and so on. A specific location of any particular RFID-tagged item in the venue is typically determined by having the server process the payloads and capture data from a plurality of the readers by using triangulation techniques known in the art.

As advantageous as such known RFID systems have been in identifying, locating and tracking items with RFID tags, especially low-cost passive tags, it has proven difficult in practice to accurately and rapidly locate each tag, especially when one or more of the tags have moved, as well as when there is a multitude, e.g., a tag population of many thousands, of such tags in the venue. Each RFID reader reads at a certain read rate, for example, about 100-200 tags per second, and it takes a certain, non-negligible amount of time to read an entire tag population. Sometimes, each RFID reader has to read an individual tag more than once to accurately determine its location. When an RFID-tagged item has moved, i.e., when its location has changed to a new location, the time that it takes to provide an update of its new location is negatively affected by the presence of a large number of other tags. It is not always possible to know, at least not immediately, when a particular tag has moved, because the system must typically identify and locate all the tags before it can determine whether any particular tag has moved. The amount of time it takes to determine the new location of a tag that has moved is a linear function of the number of the tags within the coverage range of the reader(s). Real time reading performance, on the order of one second or less, for rapidly determining the new location of a tag that has moved, or for accurately locating any particular tag, is a challenge that known RFID systems have not met.

Accordingly, there is a need to more accurately and rapidly locate such tags, especially in a large RFID tag population, and to enhance the reading performance of such RFID systems.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a broken-away, perspective, schematic view, as seen from above, of a system installed in an exemplary controlled area, and operative for reading RFID tags in real time with an enhanced performance in accordance with the present disclosure.

FIG. 2 is a block diagram of a representative RFID reader of the system of FIG. 1.

FIG. 3 is a flow chart depicting steps performed in accordance with a method of reading RFID tags in real time with an enhanced performance in accordance with the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to a radio frequency (RF) identification (RFID) tag reading system for reading RFID tags in a controlled area in real time with an enhanced performance. The controlled area may be a retail store, a warehouse, or any other confined or open area in which RFID-tagged items are to be monitored. The controlled area may be indoors or outdoors, and may be a single sector or volume of space, or may be, and often is, subdivided into multiple sectors. The system includes an RFID reader for reading a mixed tag population of interesting RFID tags, which are associated with items of interest, and of uninteresting RFID tags, which are associated with items of no or little or less interest, in the controlled area at a read rate. A controller or programmed microprocessor is operatively connected to the RFID reader, and dynamically monitors the read rate in real time, preferably continuously. The controller also dynamically selects the interesting RFID tags, or deselects the uninteresting RFID tags, in real time when the read rate is below a reading threshold, and dynamically controls the RFID reader in real time to only read the interesting RFID tags when the read rate is below the reading threshold. Thus, by limiting the reading to only the interesting RFID tags, there are fewer tags to be read, and they can be read more rapidly and more accurately than heretofore.

In one embodiment, the RFID reader has an array of antenna elements, e.g., a phased array, and an RF section that is controlled by the controller for steering beams over the controlled area. The RFID reader may also be handheld, but preferably, is mounted in an overhead location in the controlled area. The system advantageously includes a plurality of such RFID readers mounted in overhead locations in the controlled area, and the controller dynamically controls all the RFID readers in real time to only read the interesting RFID tags when the read rate is below the reading threshold. The controller may be located in any one of the readers, or in a host server that is operatively connected to all the readers. Advantageously, the controller is configured to select the interesting RFID tags when the reading threshold is a predetermined number of RFID tags per unit of time, for example, 50 tags per second, and to select the interesting RFID tags based on preselected criteria, such as the likelihood of motion of an item. The controller also may assign tag priorities to the mixed tag population, and may designate which tags are interesting and which are uninteresting or less interesting. For example, any tags on a forklift may be deemed to be the most interesting since they are either already in motion, or are most likely to be moved immediately, whereas any tags on a pallet may be deemed to be less interesting since they are less likely to be moved immediately, whereas other tags not on a forklift or pallet may be deemed to be even less interesting since they are even less likely to be moved immediately.

A method, in accordance with another aspect of this disclosure, relates to a method of reading radio frequency (RF) identification (RFID) tags in a controlled area in real time with an enhanced performance. The method is performed by reading a mixed tag population of interesting RFID tags, which are associated with items of interest, and of uninteresting RFID tags, which are associated with items of no or little or less interest, in the controlled area at a read rate; and by dynamically monitoring the read rate in real time, preferably continuously. The method is further performed by selecting the interesting RFID tags in real time, or deselecting the uninteresting RFID tags, when the read rate is below a reading threshold, and by dynamically controlling the reading in real time to only read the interesting RFID tags when the read rate is below the reading threshold.

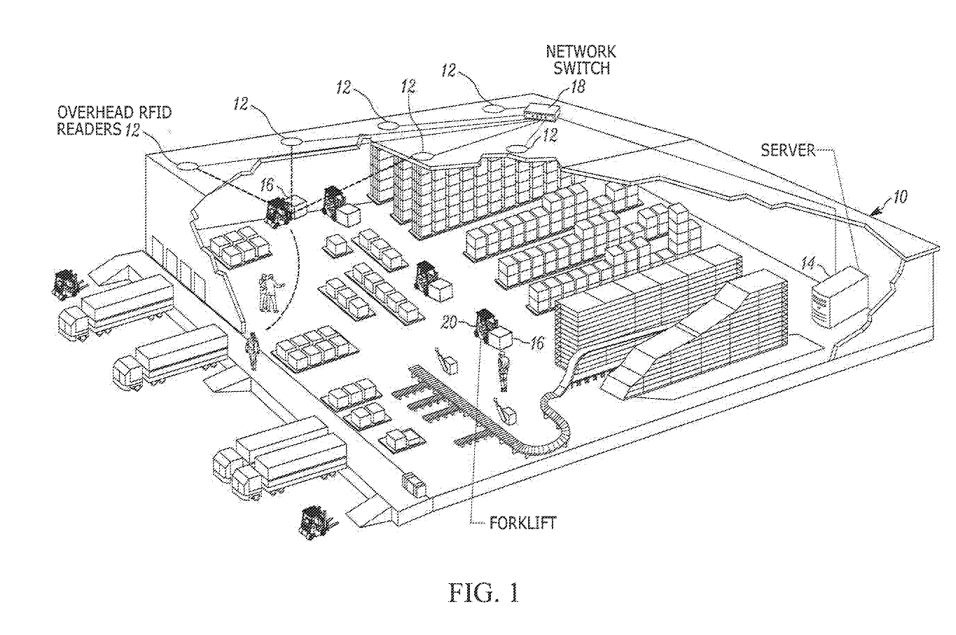

Turning now to the drawings, FIG. 1 depicts an RFID system in a warehouse environment or venue 10. A plurality of RFID tag readers 12 is mounted at overhead locations in the venue 10, preferably, but not necessarily, on the ceiling, and then operated, under the control of a controller in a network host computer or server 14 through a local area network switch 18, to interrogate and read payloads, i.e., target data, of any RFID tags that are associated with, or attached to, items 16 in a coverage range of each reader 12. The items 16 can be individual items, or packages for the items, or pallets or containers for supporting multiple items, or freight movers, such as a person, truck or forklift 20, for moving such items, packages, or pallets in the venue 10. As shown, a multitude, e.g., many thousands, of such items 16 is associated with a multitude of the tags and may be located in the coverage range of each reader 12. A specific location of any particular RFID-tagged item 16 in the venue 10 is typically determined by having the server 14 process the target data of a plurality of the readers 12 by using triangulation techniques (schematically shown by dashed lines) known in the art.

It will be understood that each RFID-tagged item 16 is preferably associated with a passive RFID tag for cost reasons, although other types of RFID tags may be employed. It will be still further understood that each reader 12 need not necessarily be deployed and stationarily mounted on the ceiling. Each reader may be handheld, or mounted at doorways, loading docks, or assembly lines. Each reader 12 may be powered from an electrical outlet, powered over the Ethernet (POE), or can be battery powered.

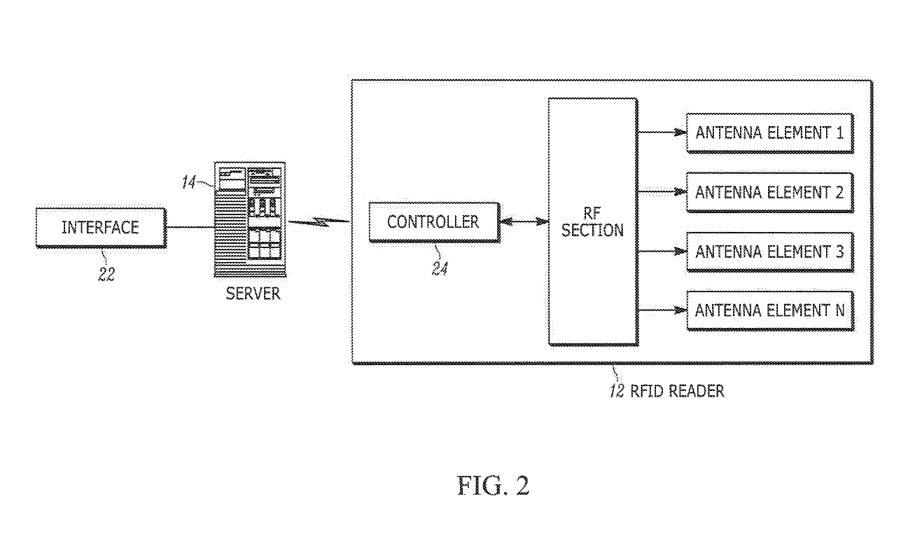

As shown in FIG. 2, each RFID reader 12 is connected to the server 14, which has a user interface 22. Each RFID reader 12, typically, but not necessarily, has an array of antenna elements 1, 2, 3 . . . , N, such as a phased array. Each RFID reader 12 also has an RF section connected to each antenna element. The number N is arbitrary and depends on the particular application. By way of non-limiting example, sixteen antenna elements may be employed. Each RFID reader 12 also has a programmed microprocessor or controller 24 that is operatively connected to the RF section to control its operation and steer beams over the tags in the controlled area. Although the controller 24 is illustrated as being located in each reader 12, the controller could also be located in the server 14, or be located in both the reader 12 and the server 14, or be located elsewhere.

The server 14 comprises one or more controllers or computers and is in wired, wireless, direct, or networked communication with the interface 22 and with each reader 12. The interface 22 provides a human/machine interface, e.g., a graphical user interface (GUI), that presents information in pictorial and/or textual form to a human user, and to initiate and/or alter the execution of various processes that may be performed by the controller in the server 14 and/or by the controller in each reader 12. The server 14 and the interface 22 may be separate hardware devices and include, for example, a computer, a monitor, a keyboard, a mouse, a printer, and various other hardware peripherals, or may be integrated into a single hardware device, such as a mobile smartphone, or a portable tablet, or a laptop computer. Furthermore, the user interface 22 can be in a smartphone, or tablet, etc., while the server 14 may be a computer, either located locally at the venue 10, or remotely at some other location, or can be hosted in a cloud server. The server 14 may include a wireless RF transceiver that communicates with each reader 12. For example, Wi-Fi and Bluetooth® are open wireless standards for exchanging data between electronic devices.

Each RFID reader 12 is normally operative for reading all the tags in its coverage range at a certain read rate, for example, about 100-200 tags per second, to locate items 16 associated with the tags. As described above, when there is a multitude, e.g., a tag population of many thousands, of tags in the venue 10, it takes a certain, non-negligible amount of time to read an entire tag population. Sometimes, each RFID reader 12 has to read an individual tag more than once to accurately determine the location of its item 16. When any such item 16 has moved, i.e., when its location has changed to a new location, the time that it takes to provide an update of its new location is negatively impacted by the presence of a large number of other tags. It is not always possible to know, at least not immediately, when a particular tag has moved, because the system must typically identify and locate all the tags before it can determine whether any particular tag has moved. The amount of time it takes to determine the new location of a tag that has moved is a linear function of the number of the tags within the coverage range of the reader(s) 12. Real time reading performance, on the order of one second or less, for rapidly determining the new location of a tag that has moved, or for accurately locating any particular tag, is a challenge not met by known RFID systems.

Hence, in accordance with this disclosure, the tags are assigned different priorities, typically by the controller in the server 14 via the interface 22. A subset of the tags is designated as interesting RFID tags, because they are associated with items of interest. Another subset of the tags is designated as uninteresting RFID tags, because they are associated with items of no or little or less interest. Tags deemed interesting are based on any preselected criteria. For example, a tag can be deemed interesting if it is associated with an item having a certain company identification, or if is associated with a certain type of item (e.g., a forklift, a pallet, a carton, a single item), or if it is associated with a likelihood that an item is in motion. A moving item is particularly interesting when it is desired to track freight or items 16 through a venue. For example, any tags on the forklift 20 may be deemed to be the most interesting since they are either already in motion, or are most likely to be moved immediately, whereas any tags on a pallet may be deemed to be less interesting since they are less likely to be moved immediately, whereas other tags not on a forklift or pallet may be deemed to be even less interesting since they are even less likely to be moved immediately.

During reading, the controller dynamically and continuously monitors the aforementioned read rate in real time. The controller also dynamically selects the interesting RFID tags, or deselects the uninteresting RFID tags, in real time when the read rate is below a certain level or reading threshold. For example, the reading threshold is a predetermined number of RFID tags per unit of time, for example, 50 tags per second. The controller also dynamically controls each RFID reader 12 in real time to only read the interesting RFID tags when the read rate is below the reading threshold. Thus, by limiting the reading to only the interesting RFID tags, there are fewer tags to be read, and they can be read more rapidly and more accurately than heretofore.

Advantageously, the controller selects the interesting RFID tags by invoking the Select Command in the ratified EPC Radio-Frequency Identification Protocols, Generation-2 Specification, Version 2.0.0. This Select Command reduces the read rate of the RFID system due to the overhead of the protocol to select the interesting RFID tags. In accordance with this disclosure, reading performance does not suffer, because the reading is limited only to the interesting RFID tags, and only when the read rate is below the reading threshold. If the read rate is above the reading threshold, then there is no need to select and read only the interesting RFID tags. The controller may also select the interesting RFID tags by invoking the Select Command to deselect the uninteresting tags. Thus, selecting the interesting RFID tags is functionally equivalent to deselecting the uninteresting RFID tags.

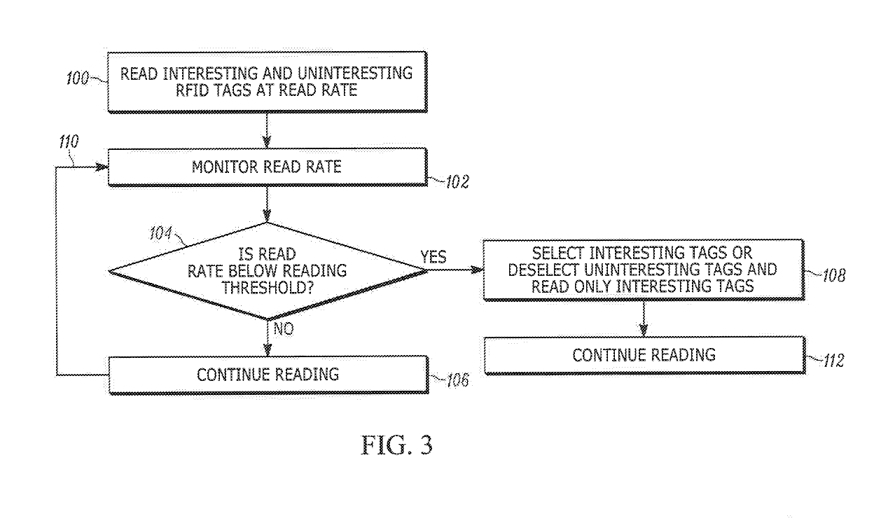

As shown in the flow chart of FIG. 3, a method of reading RFID tags in a controlled area in real time with an enhanced performance is performed, in step 100, by reading a mixed tag population of interesting RFID tags, which are associated with items of interest, and of uninteresting RFID tags, which are associated with items of no or little or less interest, in the venue 10 at a read rate. In step 102, the read rate is dynamically and continuously monitored in real time. In step 104, the controller determines whether the read rate is above or below a reading threshold. If above, then reading of the interesting RFID tags and the uninteresting RFID tags continues in step 106. As shown by a feedback line 110 in FIG. 3, the monitoring of the read rate continues during step 106. If below, then the interesting RFID tags are dynamically selected, or the uninteresting RFID tags are dynamically deselected, and the reading of only the interesting RFID tags is dynamically controlled in real time in step 108. The reading of only the interesting RFID tags continues in step 112.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A radio frequency (RF) identification (RFID) tag reading system for reading RFID tags in a controlled area in real time with an enhanced performance, the system comprising:
an RFID reader for reading a mixed tag population of interesting RFID tags, which are associated with items of interest, and of uninteresting RFID tags, which are associated with items of less interest, in the controlled area at a read rate; and
a controller operatively connected to the RFID reader, and operative for dynamically monitoring the read rate in real time, for dynamically selecting the interesting RFID tags in real time when the read rate is below a reading threshold, and for dynamically controlling the RFID reader in real time to only read the interesting RFID tags when the read rate is below the reading threshold.

2. The system of claim 1, wherein the RFID reader is mounted in an overhead location in the controlled area.

3. The system of claim 1, and additional RFID readers mounted in overhead locations in the controlled area, and wherein the controller is operatively connected to all the RFID readers to dynamically control all the RFID readers in real time to only read the interesting RFID tags when the read rate is below the reading threshold.

4. The system of claim 1, wherein the controller is configured to select the interesting RFID tags by deselecting the uninteresting tags.

5. The system of claim 1, wherein the controller is configured to continuously monitor the read rate, and wherein the controller is configured to select the interesting RFID tags when the reading threshold is a predetermined number of RFID tags per unit of time.

6. The system of claim 1, wherein the controller is configured to select the interesting RFID tags based on preselected criteria.

7. The system of claim 5, wherein one of the preselected criteria is a likelihood of motion of an item.

8. The system of claim 1, wherein the controller is further operative for assigning tag priorities to the mixed tag population, and for designating which of the RFID tags are interesting and which of the RFID tags are uninteresting.

9. A radio frequency (RF) identification (RFID) tag reading system for reading RFID tags in a controlled area in real time with an enhanced performance, the system comprising:
a plurality of RFID readers mounted in overhead locations in the controlled area, for reading a mixed tag population of interesting RFID tags, which are associated with items of interest, and of uninteresting RFID tags, which are associated with items of less interest, in the controlled area at a read rate;
a server operatively connected to the RFID readers; and
a controller located in at least one of the RFID readers and the server, and operative for dynamically and continuously monitoring the read rate in real time, for dynamically selecting the interesting RFID tags in real time when the read rate is below a reading threshold, and for dynamically controlling the RFID readers in real time to only read the interesting RFID tags when the read rate is below the reading threshold.

10. The system of claim 9, wherein the controller is configured to select the interesting RFID tags, or deselect the uninteresting RFID tags, when the reading threshold is a predetermined number of RFID tags per unit of time.

11. The system of claim 9, wherein the controller is configured to select the interesting RFID tags based on preselected criteria.

12. The system of claim 9, wherein the controller is further operative for assigning tag priorities to the mixed tag population, and for designating which of the RFID tags are interesting and which of the RFID tags are uninteresting.

13. A method of reading radio frequency (RF) identification (RFID) tags in a controlled area in real time with an enhanced performance, the method comprising:
reading a mixed tag population of interesting RFID tags, which are associated with items of interest, and of uninteresting RFID tags, which are associated with items of less interest, in the controlled area at a read rate;
dynamically and continuously monitoring the read rate in real time;
dynamically selecting the interesting RFID tags in real time when the read rate is below a reading threshold; and
dynamically controlling the reading in real time to only read the interesting RFID tags when the read rate is below the reading threshold.

14. The method of claim 13, wherein the reading is performed by an RFID reader, and mounting the RFID reader in an overhead location in the controlled area.

15. The method of claim 13, wherein the reading is performed by a plurality of RFID readers, and mounting all the RFID readers in overhead locations in the controlled area, and controlling all the RFID readers in real time to only read the interesting RFID tags when the read rate is below the reading threshold.

16. The method of claim 13, wherein the selecting of the interesting RFID tags is performed by deselecting the uninteresting tags.

17. The method of claim 13, wherein the selecting is performed by selecting the interesting RFID tags when the reading threshold is a predetermined number of RFID tags per unit of time.

18. The method of claim 13, wherein the selecting is performed by selecting the interesting RFID tags based on preselected criteria.

19. The method of claim 18, wherein one of the preselected criteria is a likelihood of motion of an item.

20. The method of claim 13, and assigning tag priorities to the mixed tag population, and designating which of the RFID tags are interesting and which of the RFID tags are uninteresting.
